(19) United States
(12) Patent Application Publication
(10) Pub. No.: US 2026/0207306 A1
(43) Pub. Date: Jul. 23, 2026

(54) DENTAL IMPLANTS WITH CORONAL FEATURES AND SYSTEMS, DEVICES, AND METHODS FOR DESIGNING AND MANUFACTURING SAME

(71) Applicant: iDentical, Inc., Mountain View, CA (US)

(72) Inventors: Michael Finke, Alamo, CA (US); Colin Murphy, San Diego, CA (US); David Sanderson, Burlingame, CA (US)

(21) Appl. No.: 19/142,952

(22) PCT Filed: Dec. 29, 2023
(86) PCT No.: PCT/US2023/086527

§ 371 Date: Jun. 24, 2025

Related U.S. Application Data
(60) Provisional application No. 63/436,093, filed on Dec. 29, 2022.

(51) Int. Cl. A61C 8/00

(52) U.S. Cl. CPC A61C 8/0036; A61C 8/0077; A61C 2008/0046

(57) ABSTRACT

Root-analog dental implants include one or more coronal grooves that are sized, shaped, and/or configured to correspond to a size, shape, and/or position of a bone crest for an extracted tooth a root-analog dental implant is designed and manufactured to replace. The coronal grooves may be configured to engage with bone of an alveolar socket to enhance engagement between the root-analog dental implant and the alveolar socket particularly for the time period following seating the root-analog dental implant within the socket site and prior to osseointegration of the root-analog dental implant with the alveolar socket. This promotes stability of the root-analog dental implant within the socket site immediately following insertion and thereafter, which may decrease movement of the root-analog dental implant within the socket site, decrease a likelihood of foreign material such as bacteria or food entering the socket site, and/or reduce a risk of implant failure and jawbone injury.

### RELATED APPLICATION

This patent application is an INTERNATIONAL (PCT) patent application claiming priority to U.S. Provisional Application No. 63/436,093, which was filed on Dec. 29, 2022, and entitled “Dental Implants with Coronal Features and Systems, Devices, And Methods for Designing and Manufacturing Same,” which is incorporated, in its entirety, herein.

### TECHNICAL FIELD

The invention generally relates to the field of dentistry, and more particularly to the field of dental implants. The invention further relates to the field of computer-assisted designing and/or the use of additive manufacturing techniques to design and manufacture dental implants.

### BACKGROUND

Historically, traditional dental implants are placed within a site vacated by an extracted tooth after a prolonged healing phase following initial tooth extraction. During this healing phase, the bony structure of the tooth alveolar socket is reabsorbed by the body and replaced with a layer of bone and soft tissue covering the site of tooth extraction. Because these traditional dental implants come in standard shapes and sizes, a drill must be used to create an appropriately sized hole (i.e., osteotomy) within the healed-over bone to accommodate the dental implant. Unfortunately, the native hard and soft tissues around the alveolar socket are not supported during this drilling process, often resulting in bone and gumline defects commonly affecting esthetics and functional aspects of the tooth gumline. In addition, this methodology requires placement of the dental implant into soft medullary bone, which requires considerable time to fully integrate with the dental implant (i.e., osseointegration) and provide the strength and stability required for normal function. Placement of traditional dental implants may be achieved by screwing or press-fitting the dental implant into the drilled osteotomy. Following osseointegration, a permanent crown is attached to the dental implant via an attachable abutment.

This methodology may require long waiting and healing times between extraction of a damaged tooth, performance of the osteotomy, placement of the dental implant, and placement of a permanent crown for the patient. In addition, nerve damage is an inherent risk associated with drilling the required osteotomy.

### SUMMARY

Disclosed herein are root-analog dental implants and methods for designing and manufacturing same. The root-analog dental implants may be designed using information, such as three-dimensional scans, X-rays, intraoral scans, CT scans of a patient's tooth and/or mouth prior to and/or following extraction of a native tooth. In many cases, the root-analog dental implants designed and disclosed herein have a one-piece construction and may be manufactured using an additive manufacturing process using, for example, a set of design and/or manufacturing instructions developed using three-dimensional modeling and implant design processes as, for example, disclosed herein. An exterior shape of the root-analog dental implants disclosed herein may be responsive to a size, shape, and/or configuration of a tooth and/or alveolar socket prior to, or following, extraction.

The root-analog dental implants disclosed herein are configured to replace a tooth extracted from an alveolar socket of a patient. The alveolar socket may have a bone crest line that corresponds to where the top of the patient's jawbone interfaces with the tooth prior to extraction and a layer of gingiva (i.e., gums) that sit on an exterior surface of the jawbone.

In some embodiments, the root-analog dental implants disclosed herein may comprise a root portion configured to be seated in and/or occupy space within an alveolar socket from which a tooth has been extracted. The alveolar socket may be unmodified and/or slightly modified prior to seating of the root portion therein. The root-analog dental implants disclosed herein may also comprise an emergence portion positioned and configured to abut a boundary of a root portion of the root-analog dental implant and reside, at least partially, within the gingiva surrounding the alveolar socket. The root portion may transition to the emergence portion along a root boundary positioned between the root portion and the emergence portion. A shape, contour, curvature, and/or position of the root boundary, or portions thereof, may correspond to, match, and/or conform to a shape, position, and/or curvature of a bone crest line (e.g., where the tooth emerges from the jawbone) surrounding the tooth prior to extraction. A position (e.g., vertical placement) of the root boundary may be responsive to a clinician, design, and/or patient preference and/or characteristic when designed so that, for example, the root boundary resides at, or below, the bone crest line of the patient's alveolar socket. In some embodiments, the root-analog dental implants disclosed herein may further comprise an abutment positioned above (or below, depending on orientation) the emergence portion. In some embodiments, the root-analog dental implants disclosed herein may have an exterior shape that is responsive to a shape of the alveolar socket and/or extracted tooth and/or tooth root and/or may comprise only one piece. At time, the root-analog dental implants disclosed herein may be manufactured using an additive manufacturing process.

In many embodiments, the root-analog dental implants disclosed herein may include one or more coronal groove(s) circumferentially surrounding a coronal portion of the root portion of the root-analog dental implant. A size, shape, curvature, and/or position of the coronal groove(s) may correspond to a respective size, shape, curvature, and/or position of the root boundary and/or bone crest line. A distance between each coronal groove of the plurality of coronal grooves may be the same and/or may vary. At times, a number of coronal grooves included in the plurality of coronal grooves is responsive to a clinician preference and/or a patient characteristic or preference. Additionally, or alternatively, a number of coronal grooves included in the plurality of coronal grooves may be responsive to a patient characteristic, an aesthetic feature for the root-analog dental implant, a clinician preference, a characteristic of the tooth, tooth position, and/or a characteristic of the alveolar socket. For example, when the patient characteristic is low bone density surrounding the alveolar socket and the number of coronal grooves included in the plurality of coronal grooves may be more than a baseline number of coronal grooves.

In some embodiments, the root-analog dental implant may include a porous surface that may be positioned on, for example, a diaphyseal portion and an apical portion of the root portion. Additionally, or alternatively, the root portion may include a support structure such as a strut.

Additionally, or alternatively, the root portion of the root-analog dental implant disclosed herein may include one or more of an extension, a tapered horizontally oriented coronal feature, a horizontally oriented coronal feature, a vertically oriented coronal feature, an array of tapered horizontally oriented coronal features, an array of horizontally oriented coronal features, and an array of vertically oriented coronal features.

In some embodiments, the root-analog dental implants disclosed herein may be designed by receiving a size, a shape, and a bone crest feature of an extracted tooth, determining a shape of a root boundary of a root portion of the root-analog dental implant using the bone crest feature, and preparing a model of the extracted tooth using the received size, shape, and bone crest features of the extracted tooth. The model may include the root portion and an emergence portion configured to abut the root boundary of the root portion. Then, a set of instructions for fabrication of the root-analog dental implant based on the model may be generated and provided to root-analog dental implant manufacturing equipment, which may be additive manufacturing equipment such as three-dimensional printers. In some embodiments, designing the root-analog dental implants disclosed herein may include adding a coronal groove to the root portion of the model. A shape of the coronal groove may correspond to the root boundary.

In some embodiments, designing the root-analog dental implants disclosed herein may further include receiving one or more of a patient characteristic, an aesthetic feature for the root-analog dental implant (e.g., a position of a root portion of the root-analog dental implant relative to gingiva surrounding an alveolar socket from which the tooth was extracted), a clinician preference, a characteristic of the extracted tooth, and a characteristic of an alveolar socket (e.g., bone thickness and bone density) from which the extracted tooth was extracted and the model may be prepared using the one or more patient characteristic, clinician preference, characteristic of the tooth, and/or characteristic of the alveolar socket.

Additionally, or alternatively, in some embodiments, the root-analog dental implants disclosed herein may include one or more coronal groove(s) circumferentially surrounding a coronal portion a root portion (e.g., a portion of the root-analog dental implant configured to be seated within the alveolar socket from which the tooth has been extracted) of the root-analog dental implant and a curvature of the one or more coronal groove(s) may corresponding to a curvature of the bone crest line. When the root-analog dental implant includes a plurality of coronal grooves, the plurality may be arranged along a length of the coronal portion toward. In many embodiments, a shape, or curvature, of each coronal of the plurality of coronal grooves will be the same although it may be adjusted to accommodate a change (e.g., horizontal cross-sectional shape, diameter, horizontal cross-sectional area, etc.) of the coronal section along its length. In some embodiments, a distance between some, or all, of the coronal grooves of the plurality of coronal grooves may be the same (e.g., may be evenly placed). Additionally, or alternatively, a distance between some, or all, of the coronal grooves of the plurality of coronal grooves may vary (e.g., may not be evenly placed) along the length of the coronal portion.

In some embodiments, a number, size, shape, position, and/or feature of one or more of the plurality of coronal grooves may be responsive to, for example, a clinician preference, a patient characteristic, a technical feature (e.g., design limit or material used to manufacture the root-analog dental implant), an aesthetic feature for the root-analog dental implant and/or a crown to be placed over the root root-analog dental implant, a characteristic of the tooth, tooth position, and a characteristic (e.g., bone density, type, and/or thickness) of the alveolar socket. For example, when a patient characteristic is that bone density surrounding the alveolar socket is low, the number of coronal grooves included in the plurality of coronal grooves may be adjusted accordingly (e.g., may increase to, for example, seven coronal grooves from a baseline number of five coronal grooves) in response to the patient's low bone density.

In some embodiments, a portion of the root portion of the root-analog dental implant may comprise a porous surface configured to, for example, foster osseointegration between the root-analog dental implant and the alveolar socket. The porous surface may be positioned on a diaphyseal portion and an apical portion of the root-analog dental implant.

In some embodiments, the root-analog dental implants disclosed herein may include one or more support structure, such as struts, that may be configured and/or positioned within and/or on the root-analog dental implants to increase their mechanical and/or structural strength and/or integrity and/or assist the root-analog dental implants in withstanding forces exerted thereon by the patient due to, for example, chewing, grinding, and/or bruxing.

In some embodiments, the root-analog dental implants disclosed herein may include an emergence portion, a root boundary positioned between the emergence portion and the root portion, and an abutment. The emergence portion may be positioned next to the coronal portion and may be sized, shaped, configured to sit within gingiva and, in most cases, below an upper edge, or crest, of the gingiva (i.e., a gingival margin) of the patient when the root-analog dental implant is seated within the alveolar socket. In some embodiments the root boundary may be seated below the bone crest (e.g., within the alveolar socket) so that, for example, it remains below the bone crest even if some bone loss and/or reabsorption occurs around the top of the alveolar socket. In some embodiments, a shape of the root boundary may correspond to (e.g., mimic, or trace) a shape of the coronal groove. Additionally, or alternatively, a size, shape, and/or configuration of the emergence portion, root boundary, and/or abutment may be responsive to, for example, a clinician preference, a technical feature and/or a patient characteristic as, for example, disclosed herein. In some embodiments, a shape of the one or more coronal groove(s) may correspond to a shape of the emergence portion, bone crest, and/or root boundary.

In some embodiments, root-analog dental implants disclosed herein may include one or more following: an extension, a tapered horizontally oriented coronal feature, a horizontally oriented coronal feature, a vertically oriented coronal feature, an array of tapered horizontally oriented coronal features, an array of horizontally oriented coronal features, and/or an array of vertically oriented coronal features.

Methods for designing a root-analog dental implant as disclosed herein may include receiving a size, a shape, and a bone crest feature (e.g., position, shape, curvature, etc.) of an extracted tooth and preparing a model of the extracted tooth using the received size, shape, and bone crest feature of the extracted tooth. The model may include a modeled bone crest line that approximates the bone crest feature. Then, one or more a coronal grooves may be added to the model. The one or more coronal grooves may have features that correspond to the modeled bone crest line.

In some embodiments, one or more of a patient characteristic, an aesthetic feature (e.g., a position of a root portion of the root-analog dental implant relative to gingiva surrounding an alveolar socket from which the tooth was extracted) for the root-analog dental implant, a clinician preference, a characteristic of the extracted tooth, and a characteristic of an alveolar socket (e.g., bone thickness and bone density) from which the extracted tooth was extracted may be received and the model may be prepared using the one or more patient characteristic, clinician preference, characteristic of the tooth, and/or characteristic of the alveolar socket.

When the model is complete, it may be provided to root-analog dental implant manufacturing equipment such as a three-dimensional printer or other additive manufacturing equipment.

### BRIEF DESCRIPTION OF THE DRAWINGS

The present invention and embodiments thereof are illustrated by way of example, and not limitation, in the figures of the accompanying drawings in which:

FIG. 1 is a block diagram of a system, which may be used to design and manufacture a dental implant using additive manufacturing techniques, consistent with some embodiments of the present invention;

FIG. 2 is a block diagram of an exemplary processor-based system that may store data and/or execute instructions for the processes disclosed herein, consistent with some embodiments of the present invention;

FIG. 3A provides a flowchart that illustrates a first part of a process for designing a dental implant, consistent with some embodiments of the present invention;

FIG. 3B provides a flowchart that illustrates a second part of the process for designing a dental implant, consistent with some embodiments of the present invention;

FIG. 4A is a rendering of a buccal or lingual view of a tooth positioned within an alveolar socket prior to extraction, consistent with some embodiments of the present invention;

FIG. 4B is a rendering of a mesial or distal view of the tooth positioned within the alveolar socket of FIG. 4A, consistent with some embodiments of the present invention;

FIG. 5A is a rendering of a buccal or lingual view of the tooth of FIG. 4A following extraction from the alveolar socket, consistent with some embodiments of the present invention;

FIG. 5B is a rendering of a mesial or distal view of the tooth of FIG. 4A following extraction from the alveolar socket, consistent with some embodiments of the present invention;

FIG. 6 is a rendering of a buccal view of a primary model of the tooth of FIG. 4A with three cross-sectional planes superimposed thereon, consistent with some embodiments of the present invention;

FIG. 7A is a rendering of a buccal-facing view of the primary model of FIG. 6 superimposed upon a buccal-facing view of a fourth model of the tooth of FIG. 4A, consistent with some embodiments of the present invention;

FIG. 7B is a rendering of a mesial or distal-facing view of the primary model of FIG. 6 superimposed upon a mesial or distal-facing view of the fourth model of FIG. 4B, consistent with some embodiments of the present invention;

FIG. 8A is a rendering of a portion of an exemplary first version of a sixth model of a dental implant showing a coronal and/or root boundary plane, consistent with some embodiments of the present invention;

FIG. 8B provides a rendering of a portion of an exemplary second version of the sixth model of a dental implant showing a plurality of coronal and/or root boundary planes arranged along a length of a coronal portion of the root portion of the modeled dental implant, consistent with some embodiments of the present invention;

FIG. 8C provides a rendering of a portion of an exemplary third version of the sixth model that shows a plurality of coronal grooves, each coronal groove of the plurality of coronal grooves corresponding to a respective one of the plurality of coronal and/or root boundary planes shown in FIG. 8B, wherein a first coronal groove of the plurality of coronal grooves may correspond to a root boundary for the model and/or a root-analog dental implant manufactured using the model, consistent with some embodiments of the present invention;

FIG. 8D provides a close-up view of a portion of the third version of the sixth model showing the plurality of coronal grooves of FIG. 8C, consistent with some embodiments of the present invention;

FIG. 9A provides a mesial or distal view of a first version of a seventh model of a dental implant that includes an emergence portion and an abutment, consistent with some embodiments of the present invention;

FIG. 9B provides a buccal or lingual view of the first version seventh model, consistent with some embodiments of the present invention;

FIG. 10A provides a buccal or lingual view of a second version of a seventh model of a dental implant, consistent with some embodiments of the present invention;

FIG. 10B provides a mesial or distal view of the second version the seventh model, consistent with some embodiments of the present invention;

FIG. 11A provides a mesial/distal view of an exemplary eighth model of a dental implant that includes an exemplary porous surface applied to the diaphyseal and apical portions of the modeled implant root, consistent with some embodiments of the present invention;

FIG. 11B provides a buccal/lingual view of the exemplary eighth model, consistent with some embodiments of the present invention;

FIG. 12A provides a buccal/lingual view of an exemplary final model that includes an exemplary crown positioned over abutment of the root-analog dental implant model, consistent with some embodiments of the present invention;

FIG. 12B provides a mesial/distal view of the exemplary final model of FIG. 12A, consistent with some embodiments of the present invention;

FIG. 12C provides a mesial side rendering of model of the final dental implant of FIGS. 12A and 12B positioned within a CT scan of the alveolar socket from which a tooth was extracted and surrounding teeth in a subject's mouth, consistent with some embodiments of the present invention;

FIG. 13A provides a front-side of a dental implant model that includes an array of coronal grooves and a plurality of additional horizontally oriented coronal features, consistent with some embodiments of the present invention;

FIG. 13B provides a side view of the dental implant model of FIG. 13A, consistent with some embodiments of the present invention;

FIG. 14A provides a mesial or distal side view of a dental implant model that includes an array of coronal grooves and a vertically oriented coronal feature, consistent with some embodiments of the present invention;

FIG. 14B provides a mesial or distal side view of a dental implant model that includes an array of coronal grooves and a plurality of vertically oriented coronal features, consistent with some embodiments of the present invention;

FIG. 15A provides a mesial or distal side view of a dental implant model that includes an array of coronal grooves and a horizontally oriented coronal feature positioned near a porous exterior surface of the implant model, consistent with some embodiments of the present invention;

FIG. 15B provides a mesial or distal side view of a dental implant model that includes two horizontally oriented coronal features positioned near a porous exterior surface of the implant model, consistent with some embodiments of the present invention;

FIG. 16 provides a mesial or distal side view of a dental implant model that includes an array of coronal grooves and a tapered horizontally oriented coronal feature positioned near a porous exterior surface of the implant model, consistent with some embodiments of the present invention; and

FIG. 17 provides a mesial or distal side view of a dental implant model that includes an array of coronal grooves and an extension coronal feature positioned near a porous exterior surface of the implant model, consistent with some embodiments of the present invention.

Throughout the drawings, the same reference numerals, and characters, unless otherwise stated, are used to denote like features, elements, components, or portions of the illustrated embodiments. Moreover, while the present invention will now be described in detail with reference to the drawings, the description is done in connection with the illustrative embodiments. It is intended that changes and modifications can be made to the described embodiments without departing from the true scope and spirit of the present invention as defined by the appended claims.

### WRITTEN DESCRIPTION

A root-analog dental implant, as disclosed herein, may be designed using a three-dimensional scan, a CT scan, an intra-oral scan, and/or other images of a tooth and/or tooth root prior to and/or following extraction. In order to preserve shape and size information for a tooth to be extracted, it may be advantageous to atraumatically extract the tooth so it is extracted from the jaw in one (or a few) pieces that may then be scanned or otherwise imaged and used as a model to design an implant and/or implant components configured to replace the extracted tooth. On some occasions, an implant design process may use a three-dimensional scan, or other images and information, of the extracted tooth root as a base for designing a three-dimensional model of a dental implant to replace the extracted tooth that may then be fabricated using, for example, an additive manufacturing process such as three-dimensional printing. Once manufactured, a root-analog dental implant designed using one or more processes described herein may be inserted directly into the original, unmodified alveolar socket from which the scanned and/or imaged tooth/tooth root has been extracted prior to the jawbone reshaping itself to fill in the vacated alveolar socket as may occur between two to fourteen days following extraction. Thus, the root-analog dental implants described herein may be inserted within an unmodified or in some cases, a modified and/or slightly modified alveolar socket thereby eliminating the need to create an apical osteotomy as may be performed for immediate implants or to wait for the bone to grow into the vacated socket and create a subsequent osteotomy to insert a traditional screw or press-fit, cylindrically shaped, implant.

Historically, dental implants have been manufactured from solid materials using subtractive means or the removal of material until the final desired shape is achieved. This method uses mills, lathes or other machines or methods to remove materials, such as titanium, from a stock piece (e.g., cylinder or rod) thereof. These methods are advantageous especially when large quantities of identical products are manufactured. However, one disadvantage to the subtractive method of manufacturing dental implants is that it is difficult to adapt these processes to generate customized, or personalized, root-analog dental implants specific to a particular tooth because doing so would require reconfiguration of the subtractive implant fabrication equipment for each individual customized implant. These reconfiguration efforts increase time needed to manufacture the implants and increase the cost to manufacture them.

Another disadvantage to subtractive manufacturing of dental implants is the inherent limitations of the features that may be included in a dental implant. For example, there are features that may be desired (e.g., a porous exterior to promote bone growth or structural features to assist with implant durability and/or strength) that are difficult or impossible to create by subtractive means because it is difficult to carve out, or tailor, features that may be internal to (e.g., not on a surface of) a dental implant.

Additive manufacturing technology such as Powder Bed Fusion (PBD), where the raw material is in powdered form and is fused into a solid part using a highly focused heat source (e.g., a laser) provides an alternative means of forming dental implants that may be a more advantageous manufacturing method versus subtractive manufacturing in situations where dental implant design is customized for a specific patient and/or a specific tooth or if there are features desired for a dental implant that are difficult, or impossible, to achieve using subtractive manufacturing methods as may be the case when, for example, an implant with varying densities and/or varying cross-sectional structures is desired.

In some embodiments, one or more of the dental implants described herein may include one or more mechanical strength and/or support mechanisms, such as struts, rings, or spiral-shaped elements, configured to provide mechanical and/or structural strength and/or support for dental implants following insertion so that, for example, inserted dental implants may withstand various forces such as the forces and/or loads exerted on the inserted dental implant from chewing and/or tearing without failure. In some embodiments, when the support mechanisms are embodied as, for example, the struts may extend vertically from an axis and/or centerline of a dental implant body to the surface of the implant body. Additionally, or alternatively, the support structures may extend from the center of a dental implant body toward an outer surface but may not extend all the way to the surface of the implant body and, in these embodiments, the support structures may be covered by another portion of the dental implant such as a porous surface and/or lattice structure as, for example, described herein.

Support mechanisms as disclosed herein may be designed and/or configured to provide strength and stability to an implant while under, for example, loads which are not co-axial with the root centerline thus creating compressive loads and bending moment that may be exerted thereon while chewing. In some embodiments, support mechanism design (e.g., size, shape, and position on, or within, an implant) may be configured to conform with strength and load requirements for a dental implant using, for example, computer-assisted design software and/or more processes described herein.

In some cases, an implant design process may incorporate numerous factors and/or features for an implant that may be based upon one or more characteristics of the extracted tooth, jawbone, alveolar socket, and/or patient. For example, implant and/or support mechanism design and/or configuration may be based on root shape (curvature, length, amount of taper, etc.), where the tooth was positioned in the patient's jaw, jawbone characteristics proximate to an extracted tooth, and/or how much shear/compressive strain the implant is expected to experience during its lifetime. Other factors that may be incorporated into implant design and/or configuration include expected rates of osseointegration of the implant within the alveolar socket and/or whether, and to what extent, bone grafting may be necessary to ensure proper osseointegration. Additionally, or alternatively, implant and/or support structure design may be customized to accommodate one or more clinician preferences and/or to provide a design most suitable for that particular case based upon, for example, scientific evidence, clinical experience, and/or desired outcomes. For example, if a dentist or oral surgeon has a particular preferred design of implant and/or root configuration to work with, that preference may be incorporated into the design of the implant. In another example, if a clinician observes the patient has brittle, or relatively thin, bone surrounding the alveolar socket into which an implant will be placed, these observations may be considered in the design of the implant so that the implant appropriately fits within the alveolar socket and does not excessively stress certain areas of bone surrounding the alveolar socket, which may decrease a likelihood of bone failure or breakage caused by, for example, pressure exerted thereon by the implant. Additionally, or alternatively, a dentist or clinician may have varying preferences regarding a surface texture (e.g., polished, highly polished, rough, micro-textured, rough, etc.) of a portion of a root-analog implant, a shape, size, and/or count of coronal grooves, a shape, size, position, and/or crown engagement mechanism of an abutment, and/or a shape, size, position, and/or surface texturing of a transgingival section of the root-analog dental implant.

In some embodiments, support structure design and/or configuration may be responsive to analysis of, for example, a shape and/or size of the extracted tooth and/or tooth root as shown on, for example, a three-dimensional scan of the extracted tooth root, an X-ray, an intra-oral scan of the tooth and/or alveolar socket, and/or an external scan such as a CT or MRI scan.

Support structures embodied as struts may be of any cross-sectional size, shape, or combination of shapes including, but not limited to, square, rectangular, star, hexagonal, rounded, triangular, a plurality of curved extensions, and I-beam shaped. In some cases, a support structure size and/or orientation may change along the length of the implant root section. For example, a support structure may be thinner near an apex of a root section and gradually increase in thickness to a maximum thickness at, or near, a coronal section. Additionally, or alternatively, a dimension (e.g., thickness, width, or height) of a support structure may be proportional to an overall size of a root section of an implant so that as a cross-sectional area of the root section decreases from the coronal section to the apex section, a dimension of the support structure changes in size depending on, for example, the strength requirements of the implant root and/or clinician and/or user preferences.

In embodiments where both support structures and a porous surface are used in a design of a root-analog dental implant; the support structure(s) may provide a micro geometry or surface texture of an implant. At times, when a support structure extends to the exterior surface of an implant, a surface of the strut coincident with the exterior surface of the implant may include small, or nano, surface features (e.g., dimples, ridges, or cross hatching) that may be configured to provide a surface for bone growth. At times, a strut may provide macro geometry, a lattice and/or porous structure may provide micro geometry, and additional even smaller features, such as a nano surfacing, spikes, and/or extensions may be applied to and/or designed into one or more struts and/or portion(s) of the lattice and/or porous structure. In some embodiments, support structure strut and/or lattice design for an implant may be responsive to, for example, clinical considerations and/or preferences, tooth type, tooth position within the mouth, variations of anatomy, patient preferences and/or characteristics, crown characteristics, tooth orientation, and/or features of teeth surrounding an extracted tooth and/or implant.

At times, a shape, size, orientation, and/or configuration of one or more support structures may be responsive to, for example, characteristics of an extracted tooth root and/or an alveolar socket from which the tooth was extracted and/or where in the root-analog implant they are placed. For example, in some cases, support structures positioned on a buccal and/or lingual side of an exterior surface of a core of a root-analog implant may extend a relatively large lateral, or perpendicular, distance from an implant core and/or into a porous surface covering the core (i.e., may be shallow) to provide greater mechanical strength in this aspect. Additionally, or alternatively, struts positioned on a mesial and/or distal side of a core of a root-analog dental implant may extend a relatively small lateral, or perpendicular, distance from the exterior surface of the core since bending moments in this aspect may be relatively small.

In some embodiments, support structures may be equidistantly positioned around a circumference of a core of a root-analog dental implant. Alternatively, struts may be positioned around a circumference of a core of a root-analog dental implant in a manner that is irregular. In these cases, positioning of one or more support structures may be responsive to, for example, a characteristic of a tooth root and/or root-analog dental implant characteristic. For example, more support structures may be positioned on a buccal and/or lingual side than a mesial and/or distal side of a root-analog dental implant because the buccal and/or lingual sides of the root-analog dental implant require greater mechanical resistance to loads imparted on the functioning implant due to, for example, chewing, grinding, and/or bruxing. Positioning more support structures on the buccal and/or lingual sides of the root-analog dental implant may assist with providing mechanical strength to the implant and/or dispersion of force along the buccal and/or lingual sides of the root-analog dental implant.

Often times, a principal requirement of dental implants is that they must withstand the forces imparted on them by chewing to ensure they will not mechanically fail under maximum expected loads (tensile/compressive/shear strength) or repeated loads over time (fatigue). This includes maximum occlusive forces from a single bite as well as cyclic forces of repeated chewing over their expected life. Typically, manufacturers of dental implants test their products to ensure dental implants can withstand both maximum occlusal forces without breaking and repeated loads based on average and maximum forces for several million cycles.

Loads imparted on dental implants tend to be greatest at, or near, the top of the root portion of the dental implant (e.g., the portion of the dental implant corresponding to a coronal section) and minimal at, or near, the root portion or apex of the dental implant. For this reason, there is opportunity to remove material or increase the porosity and/or thickness of the porous surface at, or near, the apex of the dental implant since it does not contribute to dental implant function or performance.

In some embodiments, the coronal grooves disclosed herein may be sized, positioned, and/or configured to increase static friction between a seated root-analog dental implant and the alveolar socket, particularly following insertion and prior to osseointegration of the root-analog dental implant. This may lead to greater stability of the root-analog dental implant for the first few weeks following placement of the root-analog dental implant in the alveolar socket so that it may remain stable therein during the healing/osseointegration process. At times, a plurality of coronal grooves may be sized, positioned, and/or configured so that the coronal portion of the root-analog dental implant does not evenly exert force on corresponding portions of the alveolar socket, which may reduce stress on portions of the alveolar socket so that, for example, the corresponding bone does not break or resorb when the root-analog dental implant is positioned in the alveolar socket.

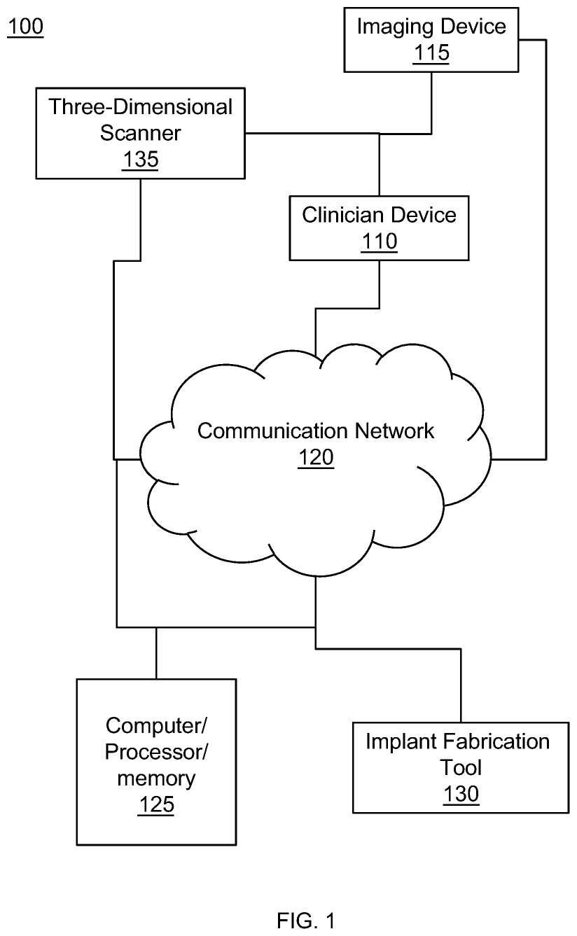

Turning now to the figures, FIG. 1 is a block diagram of a system 100, that may be used to design and manufacture a root-analog dental implant as, for example, described and shown herein using additive manufacturing techniques such as 3D laser printing. System 100 may include a clinician device 110, one or more imaging devices 115, a communication network 120, a computer/processor/memory 125, a dental implant fabrication tool 130, and/or a three-dimensional scanner 135. One or more components of system 100 may include and/or may be communicatively coupled to a display device and/or user input device (e.g., keyboard, speaker, touch screen, etc.) Communication network 120 may be any network configured to assist with the communication between two or more components of system 100. Exemplary communication networks 120 include the Internet.

Clinician device 110 may be any device, such as a computer, tablet computer, and or smart phone, which is resident in a clinician's office (e.g., dentist's office) configured to communicate with one or more devices of a system 100. Clinician device 110 may be configured to communicate patient information and or tooth extraction information to, for example, computer/processor/memory 125. In some embodiments, clinician device 110 may be in communication with imaging device 115 in order to, for example, view or gain information about one or more images of the patient's mouth, jaw, and/or teeth such as X-rays or scans. In some cases, imaging device 115 may be in the clinician's office. Additionally, or alternatively, imaging device 115 may be resident in a separate facility (e.g., hospital or medical care clinic). Exemplary imaging devices 115 include, but are not limited to, x-ray machines, intra-oral scanners, and CT scanning devices.

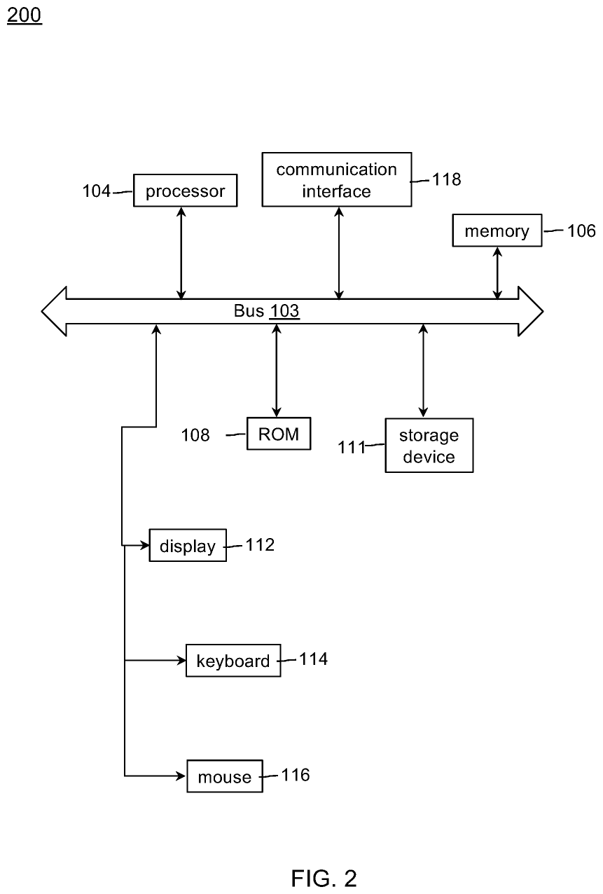

Computer/processor/memory 125 may be configured to design a dental implant that may be manufactured using additive manufacturing according to, for example, one or more of the methods disclosed herein. In some embodiments, computer/processor/memory 125 may be in communication with a processor-based system 200 as shown in FIG. 2 and described below via, for example, communication network 120. In some embodiments, computer/processor/memory 125 may be distributed and/or resident in multiple pieces of hardware that are in communication with one another via a wired and/or wireless connection (e.g., communication network 120). In some embodiments, computer/processor/memory 125 may be configured as a deep neural network capable of, for example, performing one or more operations using artificial intelligence and/or machine learning.

Three-dimensional scanner 135 may be configured to scan an extracted tooth root in three dimensions and communicate three-dimensional scans to clinician device 110 and/or computer/processor/memory 125 via communication network 120.

Dental implant fabrication tool 130 may be configured to receive instructions for the fabrication of one or more of the dental implants and/or dental implant components disclosed herein. Dental implant fabrication tool 130 may be, for example, an additive manufacturing tool and/or set of tools such as a 3D printer, a computer-aided manufacturing (CAM) module, and/or a milling machine.

In some embodiments, not all components of system 100 may be resident in the same place. For example, three-dimensional scanner 135 may be resident in a dentist's office and may communicate the three-dimensional scan of the extracted tooth root to other components of system 100 via communication network 120.

FIG. 2 provides an example of a processor-based system 200 that may store and/or execute instructions for one or more of the processes described herein. Processor-based system 200 may be resident within, for example, clinician device 110 and/or computer/processor/memory 125. Note, not all the various processor-based systems which may be employed in accordance with embodiments of the present invention have all of the features of system 200. For example, certain processor-based systems may not include a display inasmuch as the display function may be provided by a client computer communicatively coupled to the processor-based system or a display function may be unnecessary. Such details are not critical to the present invention.

System 200 includes a bus 103 or other communication mechanism for communicating information, and a processor 104 coupled with the bus 103 for processing information. System 200 also includes a main memory 106, such as a random-access memory (RAM) or other dynamic storage device, coupled to the bus 103 for storing information and instructions to be executed by processor 104. Main memory 106 also may be used for storing temporary variables or other intermediate information during execution of instructions to be executed by processor 104. System 200 further includes a read only memory (ROM) 108 or other static storage device coupled to the bus 103 for storing static information and instructions for the processor 104. A storage device 111, which may be one or more of a hard disk, flash memory-based storage medium, a magnetic storage medium, an optical storage medium (e.g., a Blu-ray disk, a digital versatile disk (DVD)-ROM), or any other storage medium from which processor 104 can read, is provided and coupled to the bus 102 for storing information and instructions (e.g., operating systems, applications programs and the like).

System 200 may be coupled via the bus 103 to a display 112, such as a flat panel display, for displaying information to a user. An input device 114, such as a keyboard including alphanumeric and other keys, may be coupled to the bus 103 for communicating information and command selections to the processor 104. Another type of user input device is cursor control device 116, such as a mouse, a trackball, or cursor direction keys for communicating direction information and command selections to processor 104 and for controlling cursor movement on the display 112. Other user interface devices, such as microphones, speakers, etc. are not shown in detail but may be involved with the receipt of user input and/or presentation of output.

The processes referred to herein may be implemented by processor 104 executing appropriate sequences of processor-readable instructions stored in main memory 106. Such instructions may be read into main memory 106 from another processor-readable medium, such as storage device 111, and execution of the sequences of instructions contained in the main memory 106 causes the processor 104 to perform the associated actions. In alternative embodiments, hard-wired circuitry, or firmware-controlled processing units (e.g., field programmable gate arrays) may be used in place of or in combination with processor 104 and its associated computer software instructions to implement the invention. The processor-readable instructions may be rendered in any computer language.

System 200 may also include a communication interface 118 coupled to the bus 103. Communication interface 118 may provide a two-way data communication channel with a computer network, which provides connectivity to the plasma processing systems discussed above. For example, communication interface 118 may be a local area network (LAN) card to provide a data communication connection to a compatible LAN, which itself is communicatively coupled to other computer systems. The precise details of such communication paths are not critical to the present invention. What is important is that system 200 can send and receive messages and data through the communication interface 218 and in that way communicate with other controllers, etc.

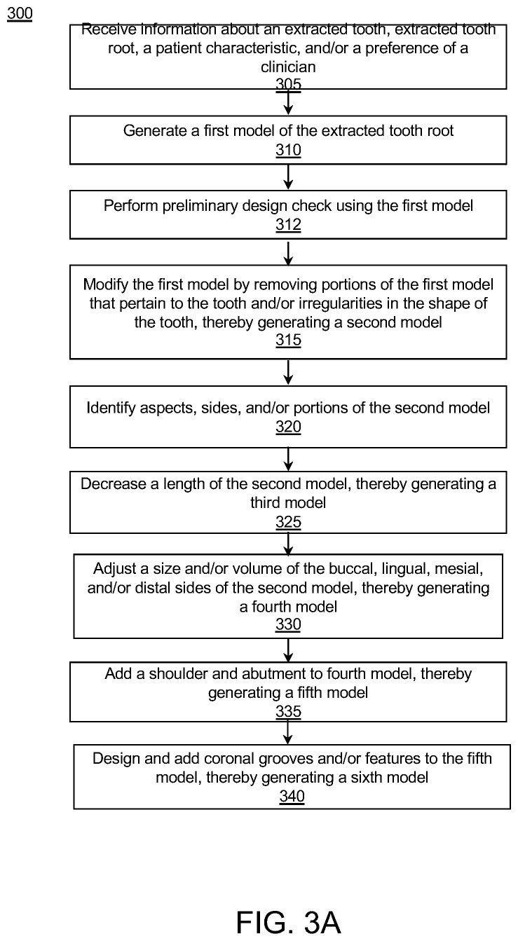

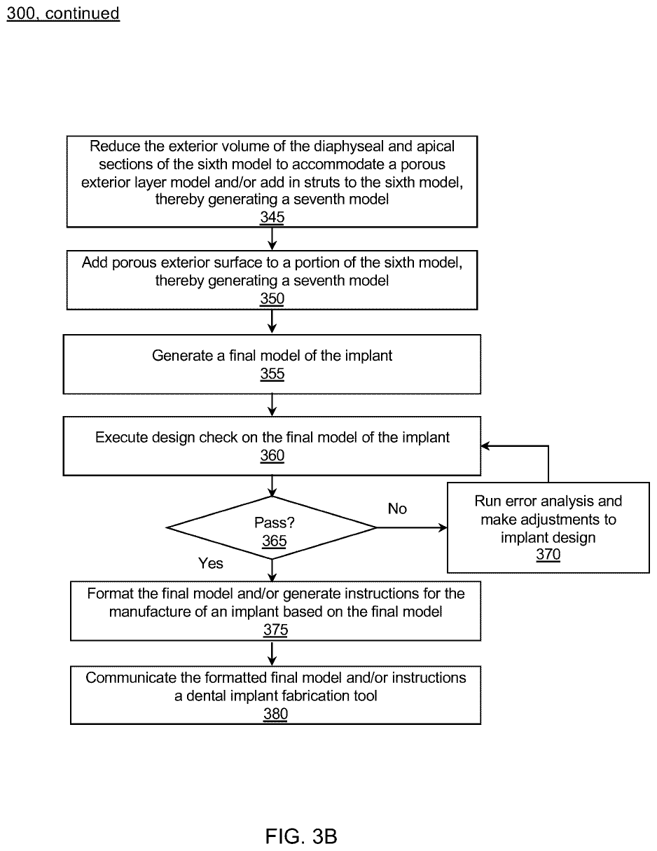

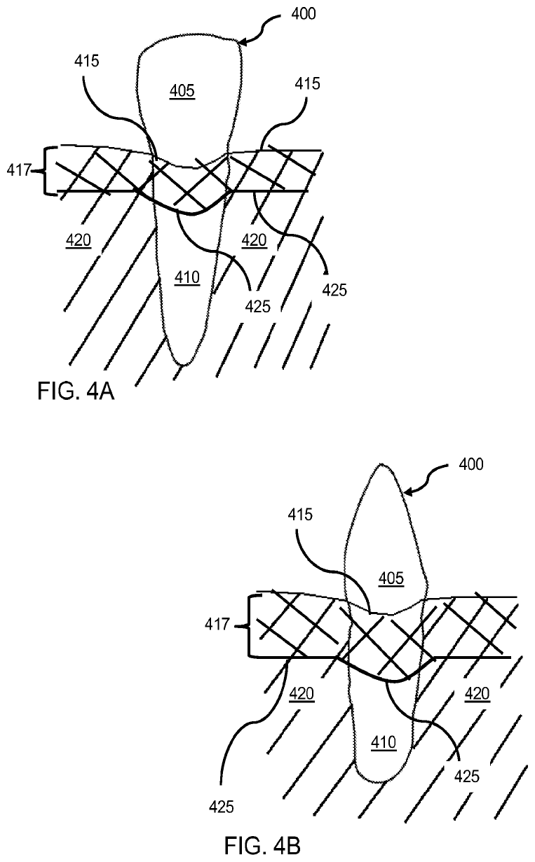

FIGS. 3A and 3B provide a flowchart that illustrates a process 300 for designing a root-analog dental implant such as the root-analog dental implants described herein. Process 300 may be executed by, for example, a processor or computer executing a set of instructions stored on a memory (e.g., memory 106) in communication with the processor (e.g., computer/processor/memory 125 and/or processor 104). In some embodiments, process 300 may be executed using one or more specifically designed and/or proprietary software packages configured to execute process 300 or portions thereof. In some cases, one or more steps of process 300 may be executed automatically via, for example, execution of a machine learning process, application of an algorithm developed via a machine learning process that analyzed data from, for example, a plurality of extracted tooth roots, or via inputting information into a deep neural network configured to execute one or more steps of process 300. At times, one or more steps of process 300 may be executed via a distributed computing network and/or a local computer interfacing with a dental implant design professional. Additionally, or alternatively, in some embodiments, one or more steps of process 300 may be executed using a computer-assisted drawing software program. FIGS. 4A-17 provide a series of drawings that depict an extracted tooth and a series of iterations to a model of a dental implant as may occur during execution of a dental implant design process like process 300 and will be discussed below with regard to exemplary relevant steps of process 300.

In step 305, information regarding a tooth to be extracted, an extracted tooth, an extracted tooth root, and/or a patient from whom a tooth has been extracted may be received by, for example, a processor-based system, which in some embodiments may include a processor configured to incorporate a computer-aided design (CAD) module such as computer/processor/memory 125. In many cases, the information received in step 305 includes one or more two- or three-dimensional image(s) and/or scan(s) of an extracted tooth root, fractured pieces of an extracted tooth root, and/or an alveolar socket from which the tooth has been extracted. This information may be received from/via, for example, an intra-oral scanner, an X-ray image, a CT scan image, a three-dimensional scanner like three-dimensional scanner 135, and/or a clinician device like clinician device 110. Additionally, or alternatively, the information received in step 305 may be a scan of the patient's jaw and teeth such as Cone-beam Computed Tomography (CbCT), a tooth, and/or tooth root prior to, or following extraction, and/or a scan of a patient tooth/tooth root and adjacent teeth and/or opposing dentition. These scans may be, for example, CT scans, X-rays, and/or intraoral scans. Additionally, or alternatively, the information received in step 305 may be one or more patient characteristics such as gender, age, bone health, anticipated healing rates, bone thickness, bone density, and/or aesthetic considerations.

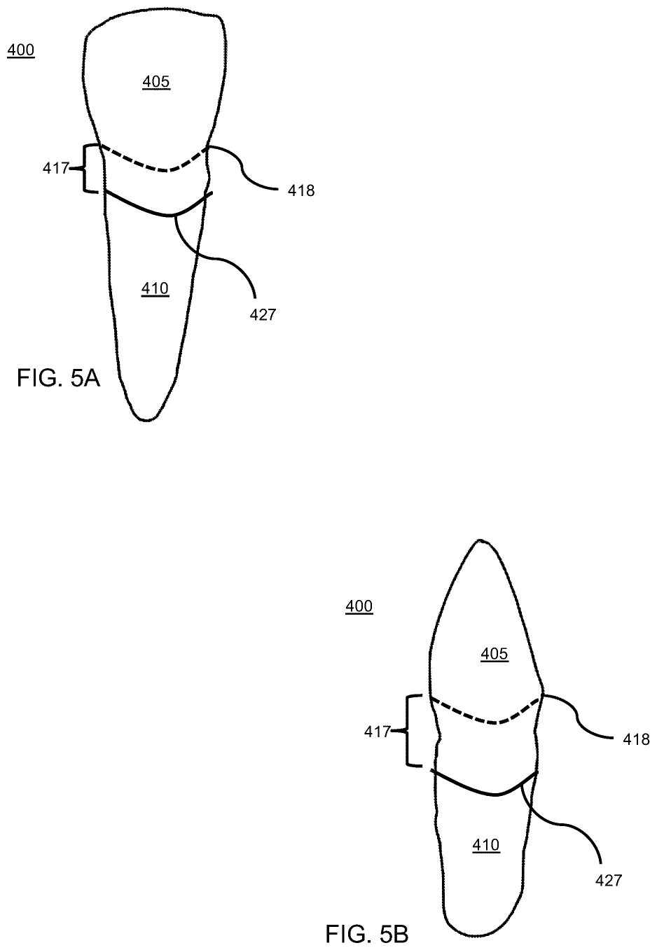

The renderings of FIGS. 4A, 4B, 5A, and 5B provide examples of information that may be received in step 305. In particular, FIG. 4A provides a rendering of a buccal view of a tooth 400 positioned within an alveolar socket prior to extraction and FIG. 4B provides a rendering of a mesial view of tooth 400 positioned within the alveolar socket. Tooth 400 includes an above-bone portion 405 and a root 410 separated from one another at the bone crest 425 of a bone 420 forming the alveolar socket. FIG. 4A and FIG. 4B also show the soft tissue, or gingiva, 417 positioned above bone 420, bone crest 425, and surrounding tooth 400 and gingiva 417. FIG. 5A provides a rendering of a buccal view of tooth 400 following extraction from bone 420 and the alveolar socket and FIG. 5B provides a rendering of a mesial view of tooth 400 once extracted from the alveolar socket. The renderings of tooth 400 provided by FIGS. 5A and 5B also provide a bone crest curve 427 and a gingival curve 418. Bone crest curve 427 delineates where, on tooth 400, bone crest 425 was prior to extraction of tooth 400 from bone 420 and gingival curve 418 delineates where, on tooth 400, gingival margin 415 was prior to extraction of tooth 400 from bone 420.

Optionally, in some embodiments, one or more patient characteristics (e.g., age, gender, bone quality, bone dimensions, bone density, general health, and/or whether the patient is immuno-compromised) and/or clinician preferences (e.g., occlusion, functional, esthetic, and/or prosthetic requirements) may be received in step 305. These characteristics and/or preferences may be used to design the root-analog dental implant models of process 300 and/or features thereof. In one example regarding patient characteristics, if a patient has relatively low bone density, thickness, and/or quality, a root-analog dental implant may be designed to exert relatively minimal force on a buccal and/or lingual surface of an alveolar socket when inserted therein

Clinician preferences that may be received in step 305 may be used to, for example, design an implant that may accommodate the clinician's preferences for inserting the implant and/or preferences for the design, function, operation, durability, and/or aesthetics of the implant. Additionally, or alternatively, clinician preferences may include preferences for a shape and/or design of the final tooth root implant. In some embodiments, information from a clinician and/or dentist about the patient and/or a clinician preference may be received in step 305 as part of, for example, a prescription for the implant. The prescription may also include, for example, aesthetic requirements for the patient and/or clinician preferences for the design of the implant some examples of which are provided in the discussion of process 300, below.

Next, in step 310, a first model of the extracted tooth root may be generated. The first model may be a two- or three-dimensional rendering of the extracted tooth (e.g., extracted tooth 400) generated using the data received in step 305 and may closely, or exactly, match the size, shape, and/or dimensions of the extracted tooth including the root and above-bone portion. In some embodiments, execution of step 310 may include determining a portion of the three-dimensional image and/or scan received in step 305 that pertains to the crown and root of the extracted tooth. This determination may be made via analysis of a position and/or shape of a crest line like crest curve 425.

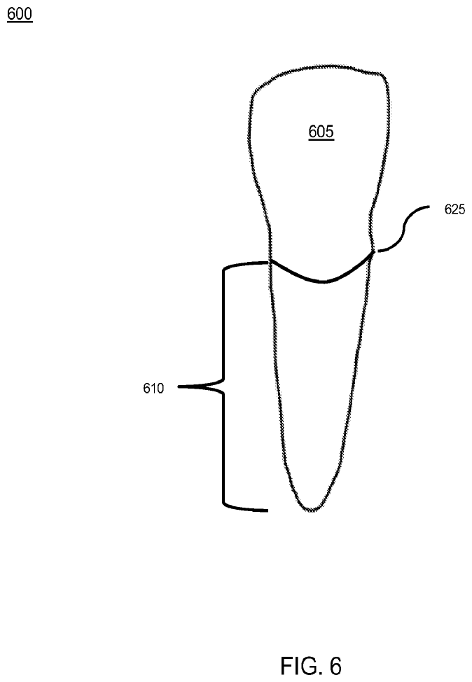

FIG. 6 provides a buccal view of an exemplary primary, or first, model 600 of tooth 400 that may be generated in step 310 using, for example, information that may be received in, for example, step 305. First model 600 may be a two- or three-dimensional rendering of tooth 400 that is unmodified (i.e., is a model that replicates the outline, dimensions, and/or shape of tooth 400). First model 600 includes a modeled crown 605 that corresponds to the size, position, and/or shape of crown 405, a modeled root 610 that corresponds to the size, position, and/or shape of root 410, and a modeled bone crest curve 625 that corresponds to the size, position, and/or shape of bone crest curve 425.

Optionally, in step 312, a preliminary design check to determine whether the extracted tooth root is suitable for and/or compatible with implant design process 300 may be performed. In some embodiments, step 312 may be executed by comparing the first model of the extracted tooth root with one or more pre-generated and/or template implant designs and/or a design envelope for implants designed using process 300 to see if the parameters of designing an implant to replace the extracted tooth are compatible with (e.g., fit within) design parameters required for implants designed using process 300. Design envelope parameters may include, for example, tooth root length, width, circumference, shape, and/or a degree of angulation in one or more directions (e.g., mesio, distal, buccal, and/or lingual sides).

In step 315, the first model of the extracted tooth root of step 310 may be modified to remove any, or all, portions of the first model that do not pertain to the tooth root (e.g., portions of the first model that correspond to tooth crown 405), thereby generating a second, or modified, model of the tooth root. In some embodiments, execution of step 315 may include removing irregularities (e.g., fragments of tissue, irregularities in tooth surface, hooked portions of the tooth root, etc.) in a shape of the three-dimensional model so that, for example, the root portion of the model has a smooth, or nearly smooth, exterior surface prior to completion of the design process. Execution of step 315 may generate a second model of the tooth for use in designing a dental implant as described herein.

In step 320, aspects, sides, and/or portions of the second model may be identified and/or determined. In some embodiments, execution of step 320 may include identification of, for example, a buccal side, a lingual side, a mesial side, a distal side, a coronal portion, a diaphyseal portion, and/or a root tip/apical area of the modified model of the tooth root.

Optionally, in step 325, a length (i.e., a distance from the bottom to the top of the tooth root) of the second model of the tooth root of step 315 may be adjusted, thereby generating a third model of the tooth for use in designing the dental implant. Adjustments executed in step 325 include, for example, shortening a height of the modified model of the tooth root by, for example, removing 0.15 mm to 0.8 mm from an edge of the model proximate to bone crest curve 625. In some embodiments, execution of step 325 may include determining an expected change in the shape and/or size (e.g., a decrease in depth and/or an expansion of a circumference) of the alveolar socket that may be caused by, for example, bone loss and/or resorption due to a natural healing process when the body/alveolar socket recovers from the tooth extraction and/or seating of a root-analog dental implant as described herein. In some embodiments, the expected change may be due to bone loss at an upper edge, or rim, of the alveolar socket that may be caused by, for example, an inflammatory response of the body following the extraction of the tooth root. A size and shape of the root portion of the dental implant may be responsive (e.g., shortened) to the expected change in the size and/or shape of the alveolar socket. At times, determining an expected change in the size and/or shape of the alveolar socket according to the healing process may be responsive to, for example, patient characteristics, tooth positioning, jawbone characteristics, etc.

In step 330, a fourth model of the tooth for use in designing the dental implant may be generated by adjusting a size, cross-sectional area, and/or volume of second (or third when step 325 is executed) model of the tooth root. Adjustments performed in step 330 include, but are not limited to, reduction of a width and/or cross-sectional diameter of the second (or third) model of the tooth root of step 315 or 325 by narrowing and/or reducing the width of the second (or third) model of the tooth root of step 315 or 325 by reducing (e.g., 0.01-0.7 mm) a diameter and/or cross-sectional area of the model in the buccal/lingual direction. In some embodiments, this adjustment may be made by, for example, moving the buccal and/or lingual edges of the model of step 315 or 325 inward by, for example, 0.01-0.7 mm along a length of the model thereby reducing the overall volume, width, and/or cross-sectional area of the tooth root model.

Additionally, or alternatively, execution of step 330 may include extending a horizontal cross-sectional area, or circumference, of the mesial and/or distal sides (along the length thereof) of the second or third model thereby creating mesial and/or distal expansion(s). In these embodiments, mesial and/or distal expansion(s) may be configured to abut and/or push into adjacent mesial and/or distal bony walls of an alveolar socket in which an implant designed via execution of process 300 is placed, which may, for example, increase a magnitude of friction and/or compression applied to the mesial and/or distal walls of the alveolar socket, which may act to initially hold the implant in place within the alveolar socket until osseointegration takes place. An exterior shape, or outline, of mesial and/or distal expansion(s) may have a curved and/or parabolic cross section so that an apex of the expansion is positioned at, or near, a longitudinal center of the fourth model in the mesial and/or distal sides. In some instances, a shape and/or size of the mesial and/or distal expansions may be a mirror image of one another and, in other instances, the size and/or shape (e.g., location of an apex, degree of curvature, etc.) may vary between mesial and distal projections. Exemplary dimensions for a width of mesial and/or distal projections are 0.1-0.75 mm along the mesial and/or distal length of the model. In some cases, a width of mesial and/or distal projections may vary along the length so that a width of mesial and/or distal projections is 0.05-0.2 mm in the cortical section, 0.02-0.3 in the diaphyseal section, and 0.01-0.35 mm in the apical sections of the root portion of the model.

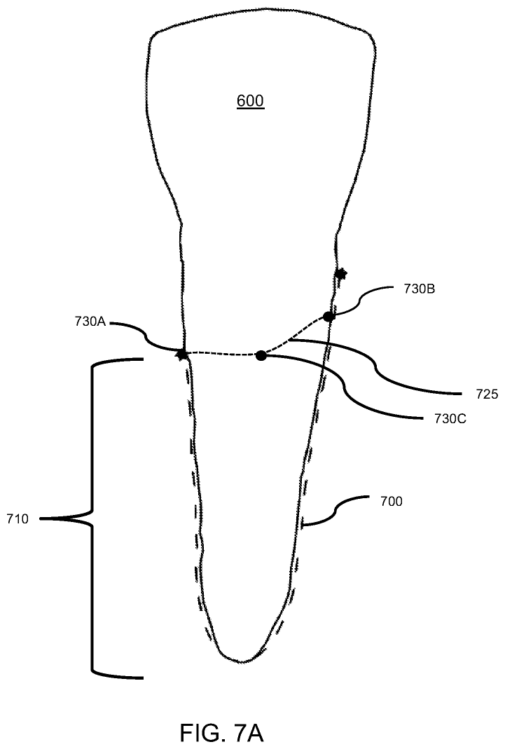

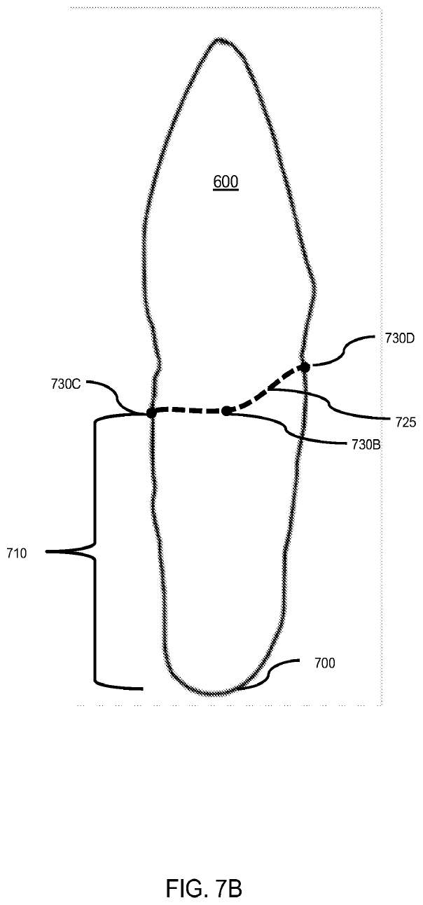

FIGS. 7A and 7B provide renderings of an exemplary fourth model 700 with a modified root portion 710 that may be generated via execution of step 330 superimposed upon first model 600 of FIG. 6. In particular, FIG. 7A provides a rendering of a mesiodistal view of first model 600 superimposed upon a corresponding mesiodistal view of the fourth model 700 (shown in broken lines). A distance between an exterior outline of first model 600 and an exterior outline of fourth model 700 represents a width of the mesial and/or distal projections for fourth model 700. FIG. 7A also shows a first, a second, and a third crest curve point 730A, 730B, and 730C, respectively, that correspond to where, on first and fourth model, a crest curve 725 corresponding to bone crest curve 425 is positioned on the mesial and/or distal side(s) of fourth model 700 as shown in FIG. 7A.

FIG. 7B provides a rendering of a buccal/lingual view of the first model 600 superimposed upon a corresponding a buccal/lingual view of the fourth model 700 (shown in broken lines). A distance between the outline of first model 600 and fourth model 700 represents a width of the buccal/lingual depressions for fourth model 600. FIG. 7B also shows second, third, and fourth crest curve points 730B, 730C, and 730D, respectively, which correspond to where, on first and fourth model, crest curve 725 is positioned on the buccal and/or lingual side(s) of fourth model 700 as shown in FIG. 7B.

In step 335, an emergence portion and an abutment may be added to the fourth model, thereby creating a fifth model of the tooth for use in designing the root-analog dental implant. The emergence portion may be configured to be positioned between the abutment and the root portion of fourth model with a root top delineating a separation between the emergence portion and the root portion of the fifth model. The root top may be configured to reside below (e.g., 0.1-1.5 mm), at, and/or slightly (e.g., 0.1-1 mm) above the bone crest (e.g., modeled crest curve 725) and the emergence portion may be configured to reside adjacent to the soft tissue or gingiva.

In some embodiments, a size (e.g., length, circumference, etc.) of the emergence portion and/or a position and/or shape of the root top may be responsive to, for example, a clinician and/or patient preference. For example, in some embodiments, an emergence portion may be relatively short and/or the root top may be vertically offset from the bone crest so that it is positioned within the alveolar socket (i.e., below (for a tooth of the lower jaw) or above (for a tooth of the upper jaw) the bone crest or modeled crest curve 725) so that a root-analog dental implant manufactured in accordance with execution of one or more steps of process 300 may remain below or above the bone crest line even following bone changes that may occur as part of the patient's healing process following extraction of the native tooth. In some cases, a size, shape, and/or configuration of emergence portion may be circumferentially or preferentially narrowed or reduce to preserve the biological width of the patient's gingival tissue.

The abutment may be configured to extend above the emergence portion and cooperate with a crown or other covering where a bottom edge of the crown or other covering may be positioned slightly below the gingival margin and extend above the gingiva.

In some embodiments, a size and/or shape of the abutment may be configured for cooperation with a crown so that the crown can be securely attached to the abutment and the crown fits and/or cooperates properly with the other teeth in the patient's mouth. At times this may be achieved via use of information received in, for example, step 305 (e.g., a pre-operative intraoral scan and/or CT scan of the patient's tooth to be extracted and surrounding teeth (e.g., height, width, ridge depth, angulation, etc.)). In some cases, the abutment may be shaped as a predesigned chamfer shape of an appropriate size (e.g., cross-sectional area, height, etc.). In some embodiments, a height for the abutment may be selected using information (e.g., height of teeth adjacent to the extracted tooth, chewing habits of the patient who had his or her tooth extracted, strength or thickness of bone making up the alveolar socket, and/or whether the patient has gum disease) provided by a dental professional (e.g., the dental professional who extracted the tooth and/or is tasked with inserting a root-analog dental implant manufactured following execution of process 300 or the dental professional who is responsible for the placement of the crown) and/or received in step 305.

In step 340, one or more coronal grooves and/or features may be added to the top section of the root portion of the fifth model that may be, for example, proximate to modeled crest curve 725. Execution of step 340 may create a sixth model of the tooth for use in designing the root-analog dental implant. The coronal grooves and/or features added via execution of step 340 may be configured and/or positioned to increase friction between a root-analog dental implant manufactured using the sixth model and the surrounding bone of an alveolar socket into which it is inserted by, for example, engaging (e.g., pushing into) with the bone and/or providing a surface area into which the bone may grow during osteointegration of the root-analog dental implant into the alveolar socket. Additionally, or alternatively, coronal grooves and/or features may be configured to inhibit entry of foreign material (e.g., fluids, solids, and/or bacteria) into the alveolar socket following bone growth into the coronal grooves and/or features of the root-analog dental implant manufactured using the sixth model.

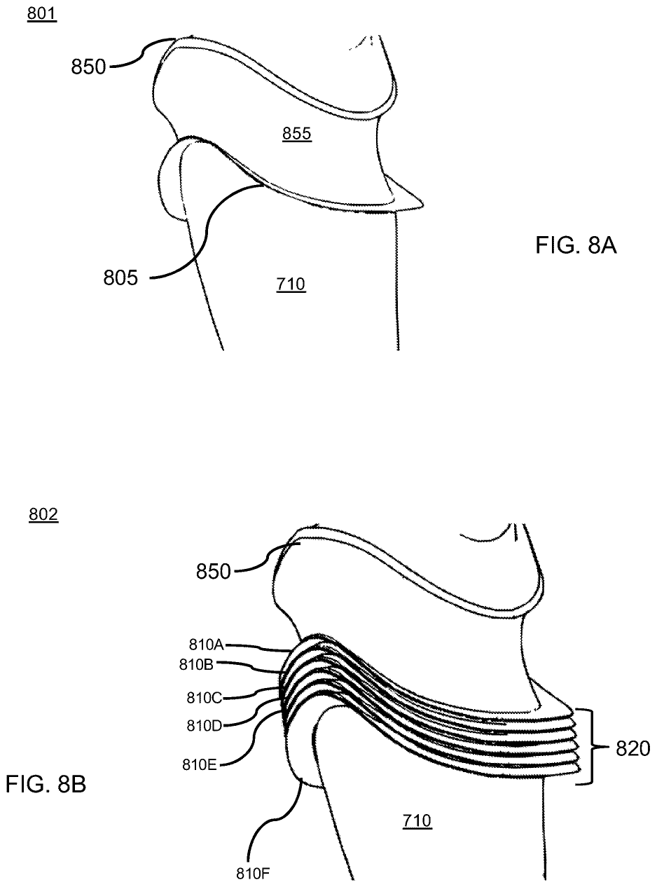

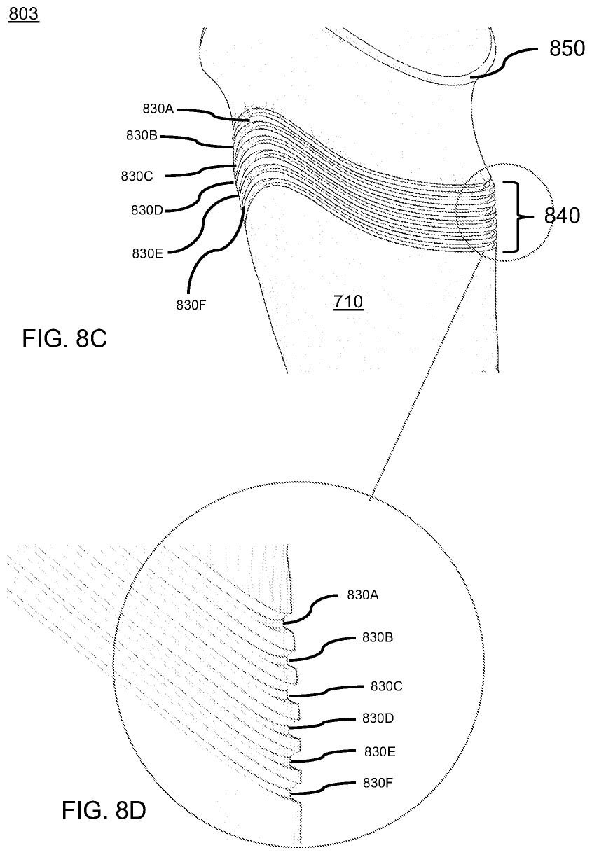

In some embodiments, one or more coronal grooves may have a shape and/or circumferential curvature that is similar to and/or mimics the bone crest curve of the extracted tooth (e.g., modeled crest curve 725 and/or 625). An example of how step 340 may be executed according to this embodiment is depicted in FIGS. 8A-8E, wherein FIG. 8A provides a close-up view of a portion of an exemplary first version of a sixth model 801 that shows a bone crest contour 805 that matches modeled crest curve 625 and/or 725 (not shown). The shape and/or curvature of bone crest contour 805 may be determined by, for example, using a computer-assisted drawing (CAD) program or other software to create a curvature intersecting and/or overlapping all, or some, points on the modeled bone crest curve. Additionally, or alternatively, bone crest contour 805 may be a smoothed or normalized version of the shape and contour of modeled crest curve 625 and/or 725. In some embodiments, bone crest contour 805 may be, correspond to, and/or define a shape, size, and/or configuration of a root boundary and/or transition point and/or line between a root portion (e.g., modified root portion 710) and emergence portion 855 of sixth model 801.

Next, a plurality of coronal groove contours may be designed and placed along the coronal portion of the sixth model (e.g. modified root portion 710). A shape, position, and/or size of coronal groove contours may be similar to a shape, size, and/or position of bone crest contour 805 as shown in, for example, FIG. 8B, which provides a close-up view of a portion of an exemplary second version of the sixth model 802 that includes an array 820 of six coronal groove lines 810 (first coronal groove line 810A, second coronal groove line 810B, third coronal groove line 810C, fourth coronal groove line 810D, fifth coronal groove line 810E, and sixth coronal groove line 810F) positioned circumferentially along a vertical length of modified root portion 710. A shape, or curvature, of each of first-sixth coronal groove contours 810A-810F is based on bone crest contour 805 shown in FIG. 8A that has been adjusted to fit an exterior shape of modified root portion 710.

Next first-sixth coronal groove lines 810A-810F may be converted into modeled coronal grooves as shown in FIGS. 8C and 8D, which respectively are a cutaway and close-up view of a portion of an exemplary third version of a sixth model 803 that includes an array 840 of six modeled coronal grooves whose shape, size, and position correspond to a respective one of array 820 of coronal groove lines 810. For example, a size, shape, and position of a first modeled coronal groove 830A corresponds to a size, shape, and position of first coronal groove contour line 810A, a size, shape, and position of a second modeled coronal groove 830B corresponds to a size, shape, and position of second coronal groove contour 810B, a size, shape, and position of a third modeled coronal groove 830C corresponds to a size, shape, and position of third coronal groove contour 810C, a size, shape, and position of a fourth modeled coronal groove 830D corresponds to a size, shape, and position of fourth coronal groove contour 810D, a size, shape, and position of a fifth modeled coronal groove 830E corresponds to a size, shape, and position of fifth coronal groove contour 810E, and a size, shape, and position of a sixth modeled coronal groove 830F corresponds to a size, shape, and position of sixth coronal groove contour 810F. Each of first-sixth modeled coronal grooves 830A-830F are embedded and/or indented into an exterior surface of modified root portion 710 and, in most cases, do not extend outward from the exterior surface of modified root portion 710.

In step 345, an exterior volume of a diaphyseal and apical section of lower root portion of the sixth model of step 340 may be reduced in size (e.g., a cross-sectional diameter along the length of the diaphyseal and/or apical sections may be reduced) in order to provide, for example, space for the application of a porous outer surface, thereby generating a seventh model of the tooth for use in designing the dental implant. Execution of step 345 may be accomplished by, for example, moving an exterior edge of the diaphyseal and/or apical sections of the sixth tooth root model inward by, for example, 0.1 mm to 1.0 mm so that a volume of the remaining diaphyseal and apical sections of the root-analog dental implant model may be reduced by, for example, 3-5%. Optionally, execution of step 345 may include adding one or more struts to sixth model to, for example, improve the structural integrity of the implant.

The porous outer surface may be from 0.1-2.0 mm deep and may be, for example, a lattice structure, and/or may include one or more holes or spaces therein in which bone may grow when a root-analog implant manufactured using a model developed via execution of process 300 is implanted into an alveolar socket. Exemplary specifications for the porous outer surface include a porosity within a range of 40-85%, surface thickness within a range of 0.1-2 mm, or 0.5-0.65 mm and an average pore size within a range of 200-600 micrometers.

In some embodiments, the porous outer surface may be a series of overlapping and/or interconnected structures or strands and/or a matrix or mesh of material. A structure of the porous outer surface may be achieved by using, for example, additive manufacturing techniques such as 3-D printing using a laser, selective laser sintering, and/or an electron beam (E-Beam) or other focused energy to fuse powdered bio-compatible materials (e.g., titanium and/or ceramic) into a specific solid form. In some examples, manufacturing of a root-analog dental implant includes overlaying the porous outer upon a base. In some embodiments, the porous outer surface may be configured to be manufactured layer-by-layer at the same time as the core, or internal components, of a root-analog dental implant. In some cases, the porous surface may be added in a uniform (e.g., a thickness of the porous covering and/or lattice network may be uniform throughout) or non-uniform (e.g., a thickness of the porous surface may not be uniform throughout) manner

In some cases, one or more features of a porous outer surface (e.g., density, diameter of threads that comprise a lattice, thickness, degree of interconnectedness, overlapping patterns, pattern, width, length, etc.) may be configured responsively to, for example, strength and/or application requirements for dental implants and/or clinician preferences. In some embodiments, one or more porous surface characteristics may be configured to match and/or be compatible with bone characteristics of the alveolar socket and/or extracted tooth characteristics. Exemplary bone and/or tooth characteristics include, but are not limited to, density, tissue type, and whether disease is present in a patient's mouth and/or body. In some embodiments, a porous outer surface or a portion thereof may include one or more protrusions that extend from an exterior edge thereof. The protrusions may be configured to engage with the bone of the alveolar socket and improve retention within the alveolar socket. Exemplary shapes for the protrusions include spikes and knobs.

In some embodiments, a porous outer surface may include small, or nano-sized, surface features (e.g., texturing, dimples, or cross hatching) that may be configured to provide a surface texture on the outer surface of, for example, lattice pattern, strut, or other porous surface elements which would be favorable to osseointegration. At times, these features may be throughout the porous outer surface, and, at other times, the micro- or nano-sized surface texture elements may be present only on, or toward, an exterior surface of a root section of a root-analog dental implant.

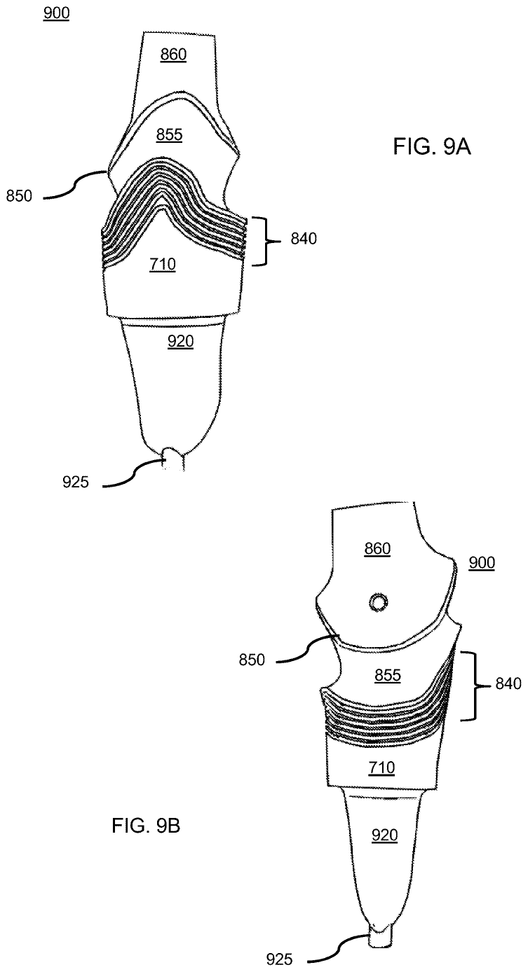

FIGS. 9A and 9B provide one example of how step 345 may be executed to generate a first version of a seventh model 900. In particular, FIG. 9A provides a mesial or distal view of first version of seventh model 900 and FIG. 9B provides a buccal or lingual view of first version seventh model 900. First version of seventh model 900 includes abutment 860, emergence portion 855, emergence boundary 850, coronal groove array 840, a portion of modified root portion 710, and a diaphyseal and apical section 920 with a reduced horizontal cross-sectional area relative to modified root portion 710 that has been reduced via execution of step 345, and a tip 925.

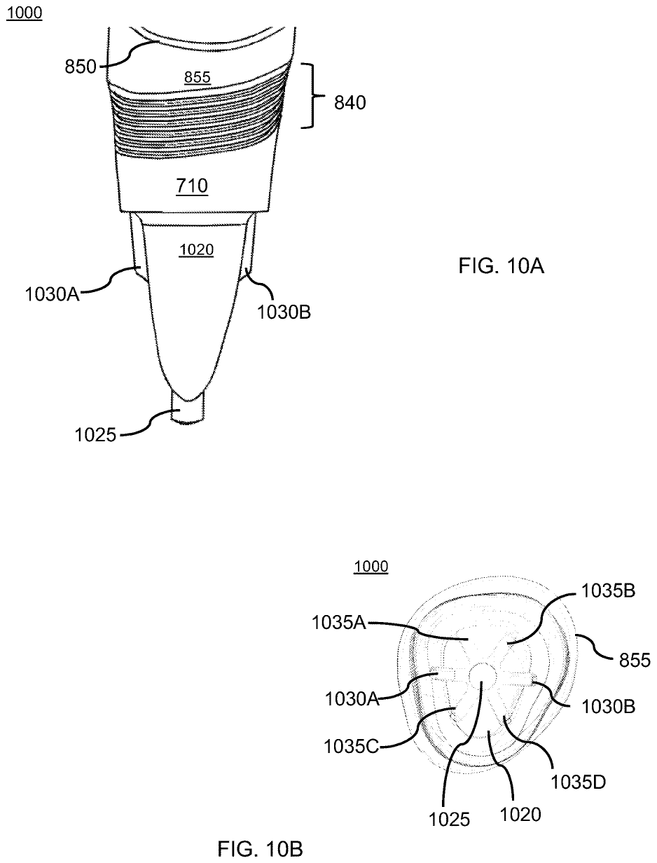

FIGS. 10A and 10B provide another example of how step 345 may be executed to generate a second version seventh model 1000. In particular, FIG. 10A provides a mesial or distal view of the second version of seventh model 1000 and FIG. 10B provides a buccal or lingual view of the second version of seventh model 1000. The second version of seventh model 1000 includes abutment 860, emergence portion 855, emergence boundary 850, coronal groove array 840, modified root portion 710, and a diaphyseal and apical section 1020 with a reduced horizontal cross-sectional area relative to modified root portion 710 that has been reduced via execution of step 345, and a tip 1025. The second version of seventh model 1000 also includes a first and third strut 1030A and 1030C that extend from the exterior surface of diaphyseal and apical section 1020. First and second struts 1030A and 1030B may be configured to provide structural support to an implant manufactured using the second version of seventh model 1000. FIG. 10B provides a bottom view of the second version of seventh model 1000 with a strut design including six struts arranged in a star-like configuration superimposed thereon. The strut design of FIG. 10B may be a base, or default, strut design that is superimposed on top of modified root portion 710 to see where (if anywhere) an exterior surface of a strut extends beyond an exterior surface of modified root portion 710 and/or of diaphyseal and apical section 1020. When an exterior surface of a strut does extend beyond an exterior surface of modified root portion 710 (as is the case with first and second struts 1030A and 1030B), the strut(s) may be included in the seventh model. When an exterior surface of a strut does not extend beyond an exterior surface of diaphyseal and apical section 1020 (as is the case with a third strut 1030C, a fourth strut 1030D, a fifth strut 1030E, and a sixth strut 1030F), the strut may not extend from the exterior surface of diaphyseal and apical section 1020 as shown in FIGS. 10A and 10B because, for example, these sides of diaphyseal and apical section 1020 may be structurally sound enough to support the root-analog dental implant and/or provide the strength required to maintain implant integrity over its lifetime while positioned within a patient's alveolar socket and patient to, for example, bite force and chewing.

Next, a porous exterior surface (e.g., a lattice or series of overlapping structures with divots or holes positioned therein) may be applied to the diaphyseal and apical sections 1020 of the seventh model, thereby generating an eighth model of the tooth for use in designing the dental implant (step 350). The external geometry of the porous exterior surface may match the external geometry of a lower root portion (e.g., modified root portion 710) of the tooth root model so that, for example, the porous exterior surface engages with the interior walls of the corresponding portions of the alveolar socket. The porous outer surface may be configured to, for example, engage with the interior walls of the alveolar socket and/or provide a surface that enables osteointegration of a root-analog dental implant with the alveolar socket.

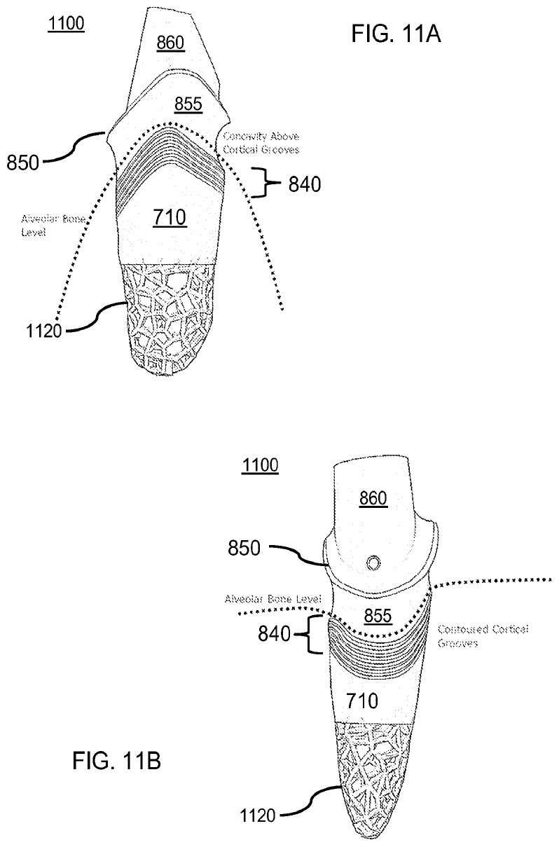

FIGS. 11A and 11B provide a mesial/distal and buccal/lingual view, respectively, of an exemplary eighth model 1100 that includes an exemplary porous outer surface 1120 applied to the diaphyseal and apical portions of seventh model 1000.

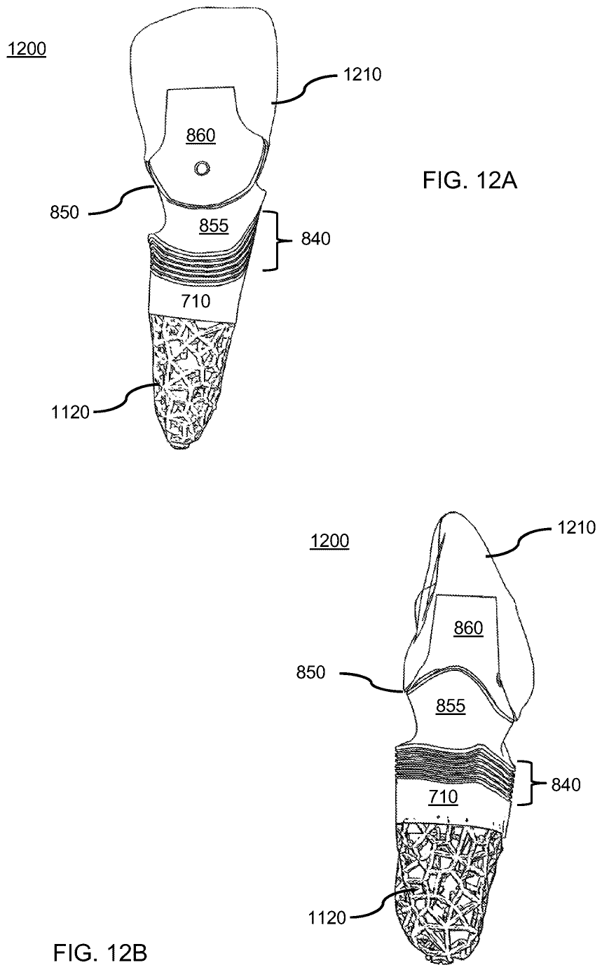

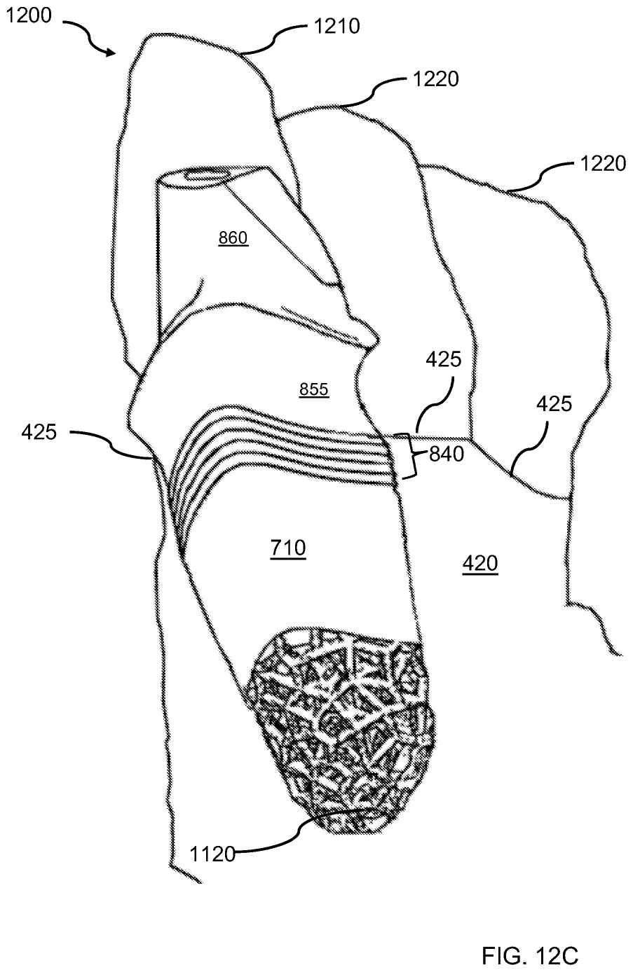

Optionally, in step 355, a final model of the implant may be designed and/or generated. Execution of step 355 may include, for example, adding a crown or other covering for the abutment. FIGS. 12A and 12B provide a buccal/lingual view and a mesial/distal view, respectively, of an exemplary final model 1200 that includes an exemplary crown 1210 positioned over abutment 860 with a shape of a lower edge of abutment 1210 matching a shape of emergence boundary 850.

Optionally, in step 360, a design check of the seventh and/or final dental root-analog dental implant model of step 360 may be performed to determine whether the dental root-analog dental implant model is appropriately designed and complies with for example, all dental implant, patient, and/or clinician requirements. Execution of the design check may include, for example, comparison of the final model of the root-analog dental implant to the original three-dimensional image and/or scan of the extracted tooth root, comparison of the final model of the dental implant to design parameters for dental implants, and/or comparison of the final root-analog dental implant model to an image, a three-dimensional scan, and/or impression of the alveolar socket from which the tooth root was extracted. In some embodiments, the design check may involve performance of steps to determine whether the dental implant will function appropriately, have, for example, adequate surface area for osteointegration and/or adequate strength (e.g., for durability and functionality). For example, the design check of step 360 may include comparing parameters of the final model against, for example, predetermined root-analog dental implant design specifications and/or requirements. For example, the design check of step 360 may include comparing a surface area of a tooth root portion of the final model and/or the strength of the dental implant at different points (e.g., which may be mathematically modeled) against specified regulatory standards such as those set forth by, for example, a governmental agency (e.g., the United States Food and Drug Administration (FDA) and/or European Medicines Agency) and/or a medical and/or dental review organization or association (e.g., the United States American Dental Association (ADA) and/or the European Association of Dental Public Health (EADPH)).

In some embodiments, execution of step 360 includes overlaying a rendering of the seventh model and/or final implant model to an image (e.g., MRI, CT scan, intraoral scan, and/or X-ray) of the patient's jaw or mouth to see how an implant manufactured using the seventh and/or final model may fit within the alveolar socket and/or patient's mouth relative to, for example, other teeth in his or her mouth. FIG. 12C provides a mesial side rendering of model 1200 positioned within a CT scan of the alveolar socket from which tooth 400 was extracted. This rendering may be examined to determine whether, for example, the coronal grooves align with the crest of the alveolar socket and/or the implant properly fits within the patient's alveolar socket.

If the seventh and/or final model does not pass the design check (step 365), an error analysis of the seventh and/or final model may be run so that adjustments may be made to the seventh and/or final model (step 370). Following these adjustments, step 360 may be iteratively executed again. If the seventh and/or final model passes the design check (step 365), the seventh and/or final model may be formatted for manufacturing (step 375). In some embodiments, execution of step 375 may include generation of one or more instructions for the manufacture of a root-analog dental implant based on the seventh and/or final model. In some cases, execution of step 375 includes translating the seventh and/or final model into CAM software for communication to a manufacturing device (e.g., a three-dimensional printer). In some embodiments, execution of step 375 may include receiving, or adapting, the instructions to generate the root-analog dental implant based on a material (e.g., titanium or other biocompatible material) and/or an additive manufacturing process used to manufacture the root-analog dental implant. In step 380, the formatted seventh and/or final model and/or instructions for manufacturing a root-analog dental implant based upon the seventh and/or final model may be communicated to an implant fabrication tool such as a 3D printer.

In some embodiments, the coronal features added in step 325 described above may be different from those shown in FIGS. 8A-12C. For example, coronal features may include a series of extensions and/or depressions in the surface of the coronal portion of a root-analog dental implant model and/or root-analog dental implant that may be arranged in a manner that replicates, or approximates, a shape of the modeled bone crest for a tooth. Additionally, or alternatively, one or more of the implant models disclosed herein may include one or more features positioned in the coronal portion that do not approximate the shaped of a modeled bone crest such as a projection or spike.

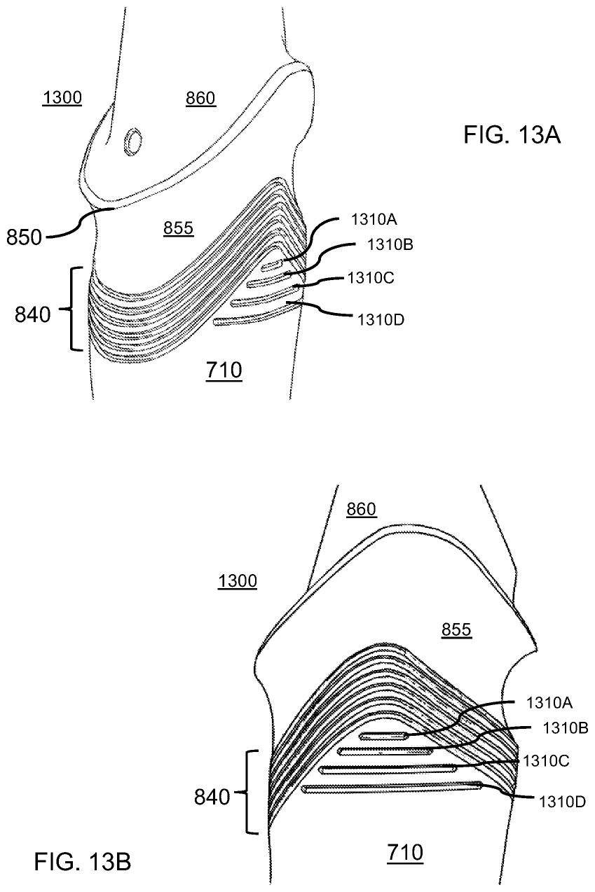

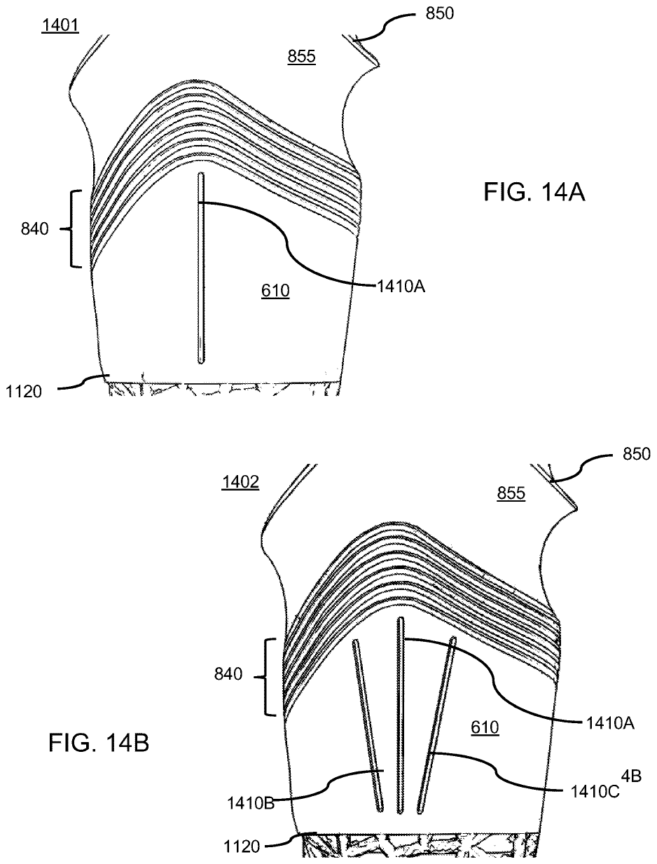

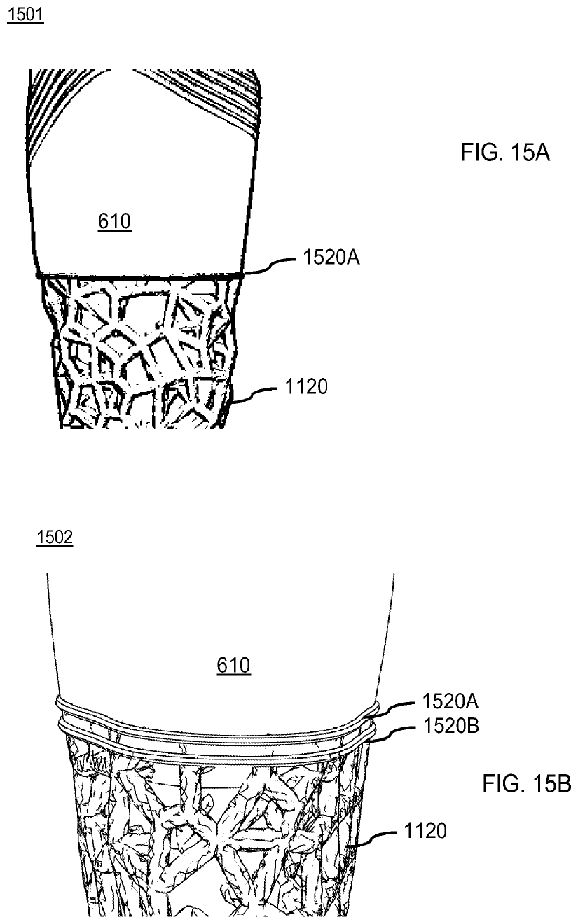

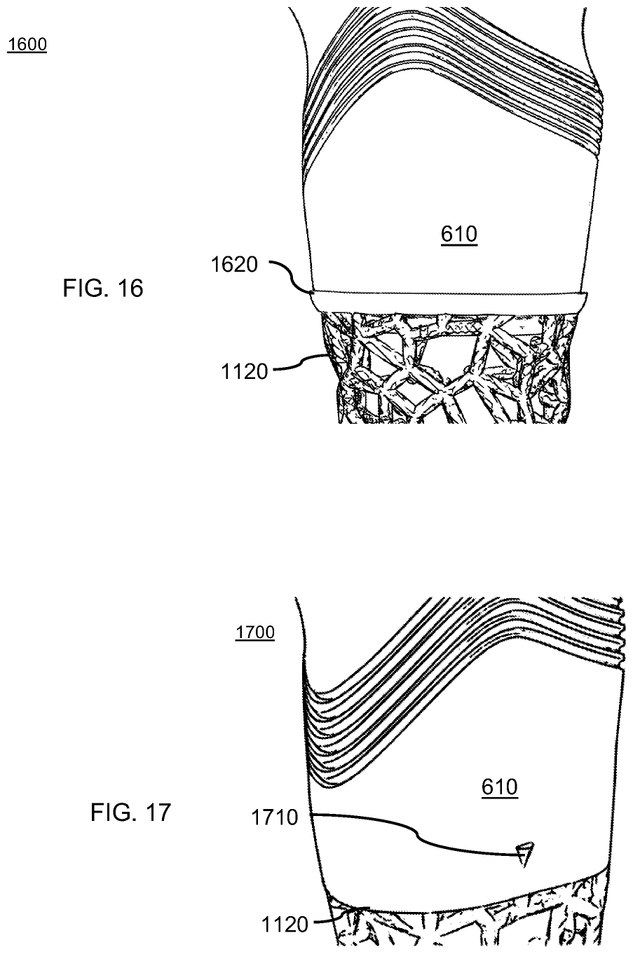

FIGS. 13A-17 provide some exemplary different coronal feature types and arrangements that may be added to a model of a dental implant via, for example, execution of step 325. For example, FIGS. 13A and 13B provide front-side and side views, respectively, of a dental implant model 1300 that includes array of coronal grooves 840 and a plurality of four horizontally oriented coronal features 1310A, 1310B, 1310C, and 1310D positioned as shown. Coronal features 1310A, 1310B, 1310C, and/or 1310D may extend from and/or be depressed into modified root portion 710. In another example, FIG. 14A provides a mesial or distal side view of a dental implant model 1401 that includes array of coronal grooves 840 and a vertically oriented coronal feature 1410A positioned below array 840 and FIG. 14B provides a mesial or distal side view of a dental implant model 1402 that includes array of coronal grooves 840 and a first, second, and third coronal feature 1410A, 1410B, and 1410C that are substantially vertically oriented and arranged in a fan-like shape. FIG. 15A provides a mesial or distal side view of a dental implant model 1501 that includes array of coronal grooves 840 and a first horizontally oriented coronal feature 1520A that circumferentially surrounds model 1501 and is positioned near a porous exterior surface of model 1501. FIG. 15B provides a mesial or distal side view of a dental implant model 1502 that includes first horizontally oriented coronal feature 1520A and a second horizontally oriented coronal feature 1520B positioned near a porous exterior surface of the implant model. FIG. 16 provides a mesial or distal side view of a dental implant model 1600 that includes array of coronal grooves 840 and a tapered horizontally oriented coronal feature 1620 positioned near a porous exterior surface of the implant model. FIG. 17 provides a mesial or distal side view of a dental implant model 1700 that includes array of coronal grooves 840 and an extension 1710 in the form of a semi-conical spike positioned near a porous exterior surface of implant model 1700.

1. A root-analog dental implant configured to replace a tooth extracted from an alveolar socket of a patient, the alveolar socket having a bone crest curve that corresponds to where an interface between the patient's tooth root and the alveolar socket terminates around the circumference of the tooth root prior to extraction, the root-analog dental implant comprising:
an emergence portion configured to abut a root boundary of a root portion of the root-analog dental implant; and
the root portion, the root portion being configured to occupy space within the alveolar socket at or below the bone crest curve following extraction of the tooth, a shape of the root boundary corresponding to a shape of the bone crest curve.

2. The root-analog dental implant of claim 1, a coronal portion of the root portion further comprising:
a coronal groove circumferentially surrounding the coronal portion of the root portion of the root-analog dental implant, a shape of the coronal groove corresponding to the shape of the root boundary.

3. The root-analog dental implant of claim 2, further comprising:
a plurality of coronal grooves, each coronal groove of the plurality of coronal grooves having a shape corresponding to the shape of the root boundary.

4. (canceled)

5. (canceled)

6. (canceled)

7. The root-analog dental implant of claim 3, wherein a number of coronal grooves included in the plurality of coronal grooves is responsive to at least one of a patient characteristic, an aesthetic feature for the root-analog dental implant, a clinician preference, a feature that effects an appearance of a crown cooperating with the root-analog dental implant, a characteristic of the tooth, tooth position, and a characteristic of the alveolar socket.

8. (canceled)

9. (canceled)

10. (canceled)

11. (canceled)

12. The root-analog dental implant of claim 1, the root portion further comprising:
a support structure.

13. (canceled)

14. The root-analog dental implant of claim 1, wherein the root-analog dental implant includes an abutment positioned proximate to the emergence portion.

15. The root-analog dental implant of claim 1, wherein a shape of the emergence portion is responsive to at least one of a clinician preference and a patient characteristic.

16. The root-analog dental implant of claim 1, the root portion further comprising one or more of an extension, a tapered horizontally oriented coronal feature, a horizontally oriented coronal feature, a vertically oriented coronal feature, an array of tapered horizontally oriented coronal features, an array of horizontally oriented coronal features, and an array of vertically oriented coronal features.

17. (canceled)

18. (canceled)

19. The root-analog dental implant of claim 1, wherein a shape of at least one of the emergence portion and the root portion is responsive to at least one of a clinician preference and a patient characteristic.

20. The root-analog dental implant of claim 1, wherein the root boundary closely matches to a shape of the bone crest curve.

21. (canceled)

22. (canceled)

23. (canceled)

24. (canceled)

25. (canceled)

26. (canceled)

27. A root-analog dental implant configured to replace a tooth extracted from an alveolar socket of a patient, the alveolar socket having a bone crest curve that corresponds to where an interface between the patient's tooth root and the alveolar socket terminates around the circumference of the tooth root prior to extraction, the root-analog dental implant comprising:
a coronal groove circumferentially surrounding a coronal portion of a root portion of the root-analog dental implant, a curvature of the coronal groove corresponding to a curvature of the bone crest curve.

28. The root-analog dental implant of claim 27, further comprising:
a plurality of coronal grooves.

29. (canceled)

30. (canceled)

31. (canceled)

32. The root-analog dental implant of claim 27, wherein a number of coronal grooves included in the plurality of coronal grooves is responsive to at least one of a patient characteristic, an aesthetic feature for the root-analog dental implant, a clinician preference, a characteristic of the tooth, tooth position, and a characteristic of the alveolar socket.

33. (canceled)

34. (canceled)

35. (canceled)

36. The root-analog dental implant of claim 27, wherein an exterior shape of the root-analog dental implant is responsive to a shape of the alveolar socket.

37. The root-analog dental implant of claim 27, further comprising:
a support structure.

38. (canceled)

39. (canceled)

40. The root-analog dental implant of claim 27, the root-analog dental implant further comprising:
an emergence portion configured to abut a root boundary of a root portion of the root-analog dental implant; and
the root portion, the root portion being configured to occupy space within the alveolar socket at or below the bone crest curve following extraction of the tooth, a shape of the root boundary corresponding to a shape of the bone crest curve.

41. The root-analog dental implant of claim 40, wherein a shape of the emergence portion is responsive to at least one of a clinician preference and a patient characteristic.

42. The root-analog dental implant of claim 40, wherein a shape of the coronal groove further corresponds to a shape of the root boundary.

43. The root-analog dental implant of claim 27, further comprising one or more of an extension, a tapered horizontally oriented coronal feature, a horizontally oriented coronal feature, a vertically oriented coronal feature, an array of tapered horizontally oriented coronal features, an array of horizontally oriented coronal features, and an array of vertically oriented coronal features.

44. (canceled)

45. (canceled)

46. (canceled)

47-51. (canceled)
